(19) United States
(12) Patent Application Publication
(10) Pub. No.: US 2025/0284623 A1
(43) Pub. Date: Sep. 11, 2025

(54) SYSTEMS AND METHODS FOR PATTERN RECOGNITION

(71) Applicant: Samsung Electronics Co., Ltd., Suwon-si (KR)

(72) Inventors: Michael Wasef, San Jose, CA (US); Andrew Chang, Los Altos, CA (US)

(21) Appl. No.: 18/772,039

(22) Filed: Jul. 12, 2024

Related U.S. Application Data
(60) Provisional application No. 63/561,453, filed on Mar. 5, 2024.

(51) Int. Cl. G06F 12/02

(52) U.S. Cl. CPC G06F 12/02; G06F 12/0215; G06F 2212/1016; G06F 2212/6026

(57) ABSTRACT

Systems and methods for pattern recognition are described. A storage device may include a first storage medium; a processor configured to: identify a first distance between first memory addresses accessed by a computing device that satisfies a first criterion; based on identifying the first distance that satisfies the first criterion, identify a second distance between second memory addresses accessed by the computing device that satisfies a second criterion; based on identifying the second distance that satisfies the second criterion, detect a pattern including the first distance and the second distance; and retrieve from the first storage medium, based on the pattern, data associated with a third memory address.

### CROSS-REFERENCE TO RELATED APPLICATION(S)

The present application claims priority to and the benefit of U.S. Provisional Application No. 63/561,453, filed Mar. 5, 2024, entitled “RUN-TIME PATTERN RECOGNITION ALGORITHM TO PREDICT HOST ACCESS FOR EFFECTIVE PREFETCHING,” the entire content of which is incorporated herein by reference. The present application is also related to U.S. Application entitled “SYSTEMS AND METHODS FOR GROUPING MEMORY ADDRESSES”, and U.S. Application entitled “SYSTEMS AND METHODS FOR IDENTIFYING REGIONS OF A MEMORY DEVICE”, both of which are filed on even date herewith, the content of both of which are incorporated herein by reference.

### FIELD

One or more aspects of embodiments according to the present disclosure relate to memory devices, and more particularly to systems and methods for pattern recognition for predicting access to a memory device.

### BACKGROUND

An application running on a host computing device may need to read and write data to memory. As the amount data read and written to memory increases, the demand for storage devices and memory, and efficiently accessing the storage devices and memory, may also increase.

The above information disclosed in this Background section is only for enhancement of understanding of the background of the present disclosure, and therefore, it may contain information that does not form prior art.

### SUMMARY

One or more embodiments of the present disclosure are directed to a storage device comprising: a first storage medium; a processor configured to: identify a first distance between first memory addresses accessed by a computing device that satisfies a first criterion; based on identifying the first distance that satisfies the first criterion, identify a second distance between second memory addresses accessed by the computing device that satisfies a second criterion; based on identifying the second distance that satisfies the second criterion, detect a pattern including the first distance and the second distance; and retrieve from the first storage medium, based on the pattern, data associated with a third memory address.

According to some embodiments, the storage device further includes a second storage medium including volatile memory, wherein the processor is configured to retrieve data from the first storage medium and store the data in the second storage medium.

According to some embodiments, the first criterion is satisfied upon detecting a first preset number of accesses associated with the first distance.

According to some embodiments, the second criterion is satisfied upon detecting a second preset number of accesses associated with the second distance.

According to some embodiments, the processor is further configured to: based on identifying the second distance that satisfies the second criterion, identify a third distance between fourth memory addresses, and a fourth distance between fifth memory addresses different from the third distance; and generate a signal based on identifying the third distance and the fourth distance.

According to some embodiments, the processor is further configured to: based on identifying the second distance that satisfies the second criterion, identify the first distance between fourth memory addresses, and the second distance between fifth memory addresses; and generate a signal based on identifying the first distance between the fourth memory addresses, and the second distance between the fifth memory addresses.

According to some embodiments, the processor is further configured to: identify a first region of the first storage medium based on the first memory addresses; determine that the second memory addresses are associated with the first region; and based on determining that the second memory addresses are associated with the first region, identify the second distance between the second memory addresses.

According to some embodiments, the first region is associated with a first range of addresses, and the processor is further configured to: identify a third memory address from the first range of addresses; compute a difference between at least one of the first memory addresses and the third memory address; and determine based on the difference that the at least one of the first memory addresses is within a threshold distance from the third memory address.

According to some embodiments, the processor is further configured to: identify a second region based on the first memory addresses, wherein the second region is associated with a second range of addresses, wherein the second region is of a preset size, wherein the second region includes the first region.

According to some embodiments, the processor is configured to: identify a second region based on at least one of the first memory addresses; and identify the first region based on the processor being configured to identify the second region.

One or more embodiments of the present disclosure are also directed to a method comprising: identifying a first distance between first memory addresses accessed by a computing device that satisfies a first criterion; based on identifying the first distance that satisfies the first criterion, identifying a second distance between second memory addresses accessed by the computing device that satisfies a second criterion; based on identifying the second distance that satisfies the second criterion, detecting a pattern including the first distance and the second distance; and retrieving from a first storage medium, based on the pattern, data associated with a third memory address.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a block diagram of a system for adaptive clustering according to one or more embodiments;

FIG. 2 depicts a block diagram of a memory device according to one or more embodiments;

FIG. 3 depicts a block diagram of a prefetch engine according to one or more embodiments;

FIG. 4 depicts a conceptual block diagram of clusters and active regions according to one or more embodiments;

FIG. 5 depicts a flow diagram of a process for adaptive clustering for data prefetching according to one or more embodiments;

FIG. 6 depicts a flow diagram of a process for assigning an address to a cluster according to one or more embodiments;

FIG. 7 depicts a block diagram of a process for assigning an address to an active region according to one or more embodiments;

FIG. 8 depicts a flow diagram of a process for evaluating active regions according to one or more embodiments;

FIG. 9 depicts a flow diagram of a prefetching process according to one or more embodiments;

FIG. 10 depicts a flow diagram of a process for detecting jump patterns of addresses assigned to an active region according to one or more embodiments;

FIG. 11 depicts a block diagram of a process executed by the pattern recommender of a profiling engine for identifying a starting jump distance from which a jump pattern may be formed according to one or more embodiments;

FIG. 12 depicts a flow diagram of a process for identifying a jump pattern according to one or more embodiments;

FIG. 13 depicts a conceptual diagram of the jump distances that are monitored and recorded by a pattern predictor for determining a jump pattern for an active region according to one or more embodiments; and

FIG. 14 depicts a flow diagram of a process for identifying prefetch addresses based on a detected jump pattern according to one or more embodiments.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

Applications may perform computations of large amounts of data. As such types of computations increase, the demand for memory may also increase. Memory expansion technologies may help alleviate this problem by providing tiered memory subsystems that help increase memory capacity at a lower cost. The memory subsystem may include, for example, a memory device that adheres to a Compute Express Link (CXL) protocol. The memory device may include a volatile memory (e.g., a dynamic random access memory (DRAM)) and a non-volatile memory (NVM).

An application running on the host device may read and write data to the memory device via load and store commands, treating the memory device as an expansion of the main memory that is attached to the processor. Latencies are generally involved in accessing the memory device. The latencies involved may differ depending on the storage medium storing the data that is to be retrieved. For example, the memory device may have both a volatile storage medium (e.g., dynamic random access memory (DRAM)) and a non-volatile storage medium (e.g., NAND flash memory). The latencies of the volatile storage medium may be lower than the latencies of the non-volatile storage medium. It may be desirable to use the volatile storage medium as cache memory where a block, chunk, or page of data (collectively referred to as a “page”) that is anticipated to be accessed soon, may be moved (e.g., prefetched) to the cache memory to minimize a cache miss that will result in access of the non-volatile storage medium.

A prefetching algorithm may be used to identify the data that is to be prefetched to the cache memory. The prefetching algorithm may predict access or temperature of the page in making the prefetching decision. For example, preference may be given to more accessed or “hot” pages than less accessed or “cold” pages, for determining the pages that are to be prefetched into the cache memory. A heat map of the application may be generated for assessing page temperature. The heat map, however, is typically generated offline. Applying an offline-generated heat map at run-time may pose a challenge due to the overhead introduced in translating the virtual addresses included in the heat map, to physical addresses.

In general terms, embodiments of the present disclosure are directed to systems and methods for using a two-level clustering model for adaptively grouping physical memory addresses accessed by a host. The two-level clustering model may include a cluster at a first level, and one or more active regions of the cluster at a second level. Access of memory addresses grouped into different active regions may be monitored by the memory device for making prefetching decisions.

In some embodiments, jumps to an active region of the memory device are monitored to detect repeated jump patterns in the physical addresses that are accessed in the active region. If a pattern is detected, the pattern may be used to predict one or more next memory addresses (e.g., next pages) that are to be accessed. The data in the predicted one or more next memory addresses may be prefetched from the non-volatile storage medium to the cache memory to improve a hit rate of the memory device.

In some embodiments, the selection of a cluster or active region to which an accessed physical memory address is to be grouped may depend on the distance (e.g., a mathematical difference) between the accessed address and the address of the center of the cluster or the center of the active region. In some embodiments, as addresses are added to the cluster, the center of the cluster may adjust.

In some embodiments, one or more counters and/or parameters are maintained for the clusters and active regions. The counters and/or parameters may be updated as physical memory addresses are added to the clusters and active regions. For example, an activity level of an active region may be updated based on accesses of memory addresses associated with the active regions (simply referred to as access of the active regions). In some embodiments, the activity level assigned to an active region determines an amount of prefetching requests that may be processed for the region.

In some embodiments, an evaluation task is executed periodically to delete active regions that have become inactive. The evaluation task may also be configured to compute a score of remaining active regions for demoting or promoting the active regions to different activity levels. The demotion or promotion of active regions may be based on a number and timing of accesses of the active region, hit or miss ratios, and/or the like.

In some embodiments, the accesses to an active region are analyzed for determining an access profile. The access profile may indicate, for example, whether the accesses are continuous or sequential, whether the accesses have a pattern, whether the accesses are random jumps to a hot region, and/or the like. Details on systems and methods for detecting random jumps to a hot region are described in further detail in “Systems and Methods for Pattern Recognition,” filed on even date herewith, the content of which is incorporated herein by reference.

In some embodiments, detecting a pattern of accesses includes determining a repeated jump pattern of the accesses. In some embodiments, a pattern recommendation algorithm (hereinafter referred to as a pattern recommender) is configured to monitor a jump distance between two consecutive addresses assigned to the same active region. If the same distance is repeated multiple times, the pattern recommender may use the distance as a starting point to detect and predict a pattern of jumps. In this regard, a pattern prediction algorithm (hereinafter referred to as a pattern predictor) may monitor the jumps that occur after the starting distance for determining a pattern. If a pattern is detected, the pattern may be used to predict one or more next memory addresses (e.g., next pages) that are to be accessed. A command may be transmitted for prefetching the predicted next memory addresses.

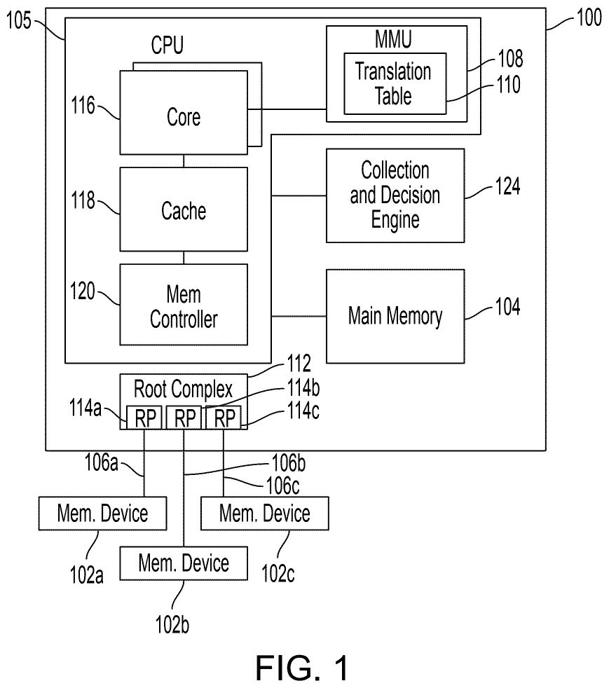

FIG. 1 depicts a block diagram of a system for adaptive clustering according to one or more embodiments. The system includes a host computing device (referred to as the “host”) 100 coupled to a one or more endpoints such as, for example, one or more memory devices 102a-102c (collectively referenced as 102).

The host 100 includes, without limitation, a processor 105, main memory 104, and root complex (RC) interface 112. The processor 105 may include one or more central processing unit (CPU) cores 116 configured to execute computer program instructions and process data stored in a cache memory (simply referred to as “memory” or “cache”) 118. The cache 118 may be dedicated to one of the CPU cores 116 or shared by various ones of the CPU cores. It should be appreciated that although a CPU is used to describe the various embodiments, a person of skill in the art will recognize that a GPU or other computing unit may be used in lieu or in addition to a CPU.

The cache 118 may be coupled to a memory controller 120 which in turn is coupled to the main memory 104. The main memory 104 may include, for example, a dynamic random access memory (DRAM) storing computer program instructions and/or other types of data (collectively referenced as data) similar to the memory device 102. In order for a CPU core 116 to execute instructions or retrieve data provided by the memory device 102, the corresponding data may be loaded into the cache memory 118, and the CPU core may consume the data (e.g., directly) from the cache memory. If the data to be consumed is not already in the cache, a cache miss may occur, and the memory device 102 may need to be queried to load the data. For example, if the data to be consumed is not in the cache 118, a cache miss logic may query the data from memory (e.g., main memory (e.g., DRAM) 104 or memory device 102) based on a mapped virtual or physical address.

In some embodiments, the processor 105 (e.g., an application running on the processor) generates data access requests for the memory devices 102. Multiple applications may be executed by the processor 105 at a given time. The multiple applications may generate numerous data access requests to the memory devices 102. One or more of the data access requests may include a virtual memory address of a location to write or read data. The processor 105 may invoke a memory management unit (MMU) 108 to translate the virtual address to a physical address for processing the request. The MMU 108 may include a translation table 110 that maps virtual addresses to physical addresses. The request transmitted to the memory device 102 for fulfilling the data access request may include the physical address corresponding to the virtual address.

In some embodiments, the host 100 exchanges signals or messages with the memory devices 102 via the RC interface 112 and interface connections 106a-106c (collectively referenced as 106). For example, the host 100 may transmit a request (e.g., a load or store request) over the RC interface 112 and interface connections 106 for reading or writing data from or to the memory devices 102. Messages from the memory devices 102 to the host 100, such as, for example, responses to the requests from the host, may be delivered over the interface connections 106 to the RC interface 112, which in turn delivers the responses to the processor 105. The memory devices 102 may further transmit signals including, for example, certain types of notifications, to the host 100 over the RC interface 112 and interface connections 106.

In some embodiments, the interface connections 106 (e.g., the connector and the protocol thereof) include a memory expansion bus such as, for example, a Compute Express Link (CXL), although embodiments are not limited thereto. For example, the interface connections 106 (e.g., the connector and the protocol thereof) may also include a general-purpose interface such as, for example, Ethernet, Universal Serial Bus (USB), and/or the like. In some embodiments, the interface connections 106 may include (or may conform to) a Cache Coherent Interconnect for Accelerators (CCIX), dual in-line memory module (DIMM) interface, Small Computer System Interface (SCSI), Fiber Channel, Serial Attached SCSI (SAS), iWARP protocol, InfiniBand protocol, 5G wireless protocol, Wi-Fi protocol, Bluetooth protocol, and/or the like.

The RC interface 112 may be, for example, a CXL interface configured to implement a root complex for connecting the processor 105 and main memory 104 to the memory devices 102. The RC interface 112 may include one or more ports 114a-114c to connect the one or more memory devices 102 to the RC. In some embodiments, the MMU 108 and/or translation table 110 may be integrated into the RC 112 interface for allowing the address translations to be implemented by the RC interface.

The memory device 102 may include one or more of a volatile computer-readable storage medium and/or non-volatile computer-readable storage medium. In some embodiments, one or more of the memory devices 102 include memory that is attached to a CPU or GPU, such as, for example, a CXL attached memory device (including volatile and persistent memory device), RDMA attached memory device, and/or the like, although embodiments are not limited thereto. The CXL attached memory device (simply referred to as CXL memory) may adhere to a CXL.mem protocol where the host 100 may access the memory using commands such as load and store commands. In this regard, the host 100 may act as a requester and the CXL memory may act as a subordinate.

In some embodiments, the memory devices 102 are included in a memory system that allows memory tiering to deliver an appropriate cost or performance profile. In this regard, the different types of storage media may be organized in a memory hierarchy or tier based on a characteristic of the storage media. The characteristic may be access latency. In some embodiments, the tier or level of a memory device increases as the access latency decreases.

In some embodiments, the one or more of the memory devices 102 are memory devices of the same or different type, that are aggregated into a storage pool. For example, the storage pool may include one or more CPU or GPU attached memory devices.

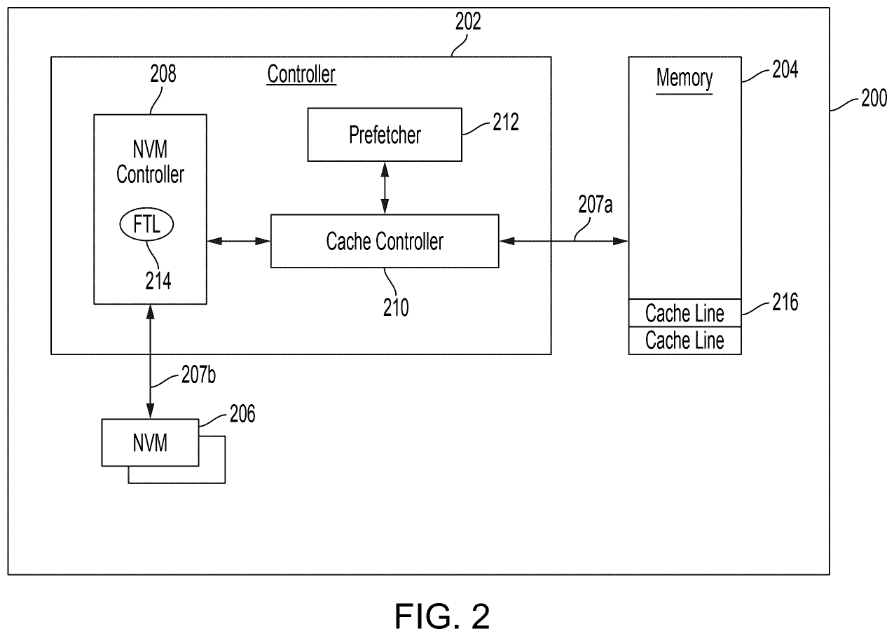

FIG. 2 depicts a block diagram of a memory device 200 according to one or more embodiments. The memory device 200 may be similar to the one or more memory devices 102 of FIG. 1. In some embodiments, the memory device 200 includes a storage controller 202, storage memory 204, and non-volatile memory (NVM) 206. The storage memory 204 may be high-performing memory of the memory device 200, and may include (or may be) volatile memory, for example, such as DRAM, but the present disclosure is not limited thereto, and the storage memory 204 may be any suitable kind of high-performing volatile or non-volatile memory. Although a single storage memory 204 is depicted for simplicity sake, a person of skill in the art should recognize that the memory device 200 may include other local memory for temporarily storing other data for the storage device.

In some embodiments, the storage memory 204 is used and managed as cache memory. In this regard, the storage memory (also referred to as a device cache memory) 204 may store copies of data stored in the NVM 206. For example, data that is to be accessed by an application in the host 100 in the near future may be copied from the NVM 206 to the storage memory 204 for allowing the data to be retrieved from the storage memory 204 instead of the NVM 206. In some embodiments, the storage memory 204 has a lower access latency than the NVM 206. Thus, in some embodiments, accessing data from the storage memory 204 helps improve overall system performance and responsiveness.

The NVM 206 may persistently store data received, for example, from the host 100. The NVM 206 may include, for example, one or more NAND flash memory, but the present disclosure is not limited thereto, and the NVM 206 may include any suitable kind of memory for persistently storing the data according to an implementation of the memory device 200 (e.g., magnetic disks, tape, optical disks, and/or the like).

The storage controller 202 may be connected to the NVM 206 and the storage memory 204 over one or more storage interfaces 207a, 207b (collectively referenced as 207). The storage controller 202 may receive input/output (I/O) requests (e.g. load or store requests) from the host 100, and transmit commands to and from the NVM 206 and/or storage memory 204 for fulfilling the I/O requests. In this regard, the storage controller 202 may include at least one processing component embedded thereon for interfacing with the host 100, the storage memory 204, and the NVM 206. The processing component may include, for example, a digital circuit (e.g., a microcontroller, a microprocessor, a digital signal processor, or a logic device (e.g., a field programmable gate array (FPGA), an application-specific integrated circuit (ASIC), and/or the like)) capable of executing data access instructions (e.g., via firmware and/or software) to provide access to and from the data stored in the storage memory 204 or NVM 206 according to the data access instructions.

In some embodiments, the storage controller 202 includes an NVM controller 208, cache controller 210, and prefetch engine 212 (also referred to as a prefetcher). Although the NVM controller 208, cache controller 210, and prefetch engine 212 are assumed to be separate components, a person of skill in the art will recognize that one or more of the components may be combined or integrated into a single component, or further subdivided into further sub-components without departing from the spirit and scope of the inventive concept.

In some embodiments, the NVM controller 208, cache controller 210, and/or prefetch engine 212 may include, for example, a digital circuit (e.g., a microcontroller, a microprocessor, a digital signal processor, or a logic device (e.g., a field programmable gate array (FPGA), an application-specific integrated circuit (ASIC), and/or the like (collectively referenced as a processor)). The digital circuit may include a memory storing instructions (e.g., software, firmware, and/or hardware code) for being executed by the processor.

In some embodiments, the NVM controller 208 is configured to receive data access requests from the host 100. The data access requests may adhere to the CXL protocol (e.g., the CXL.io, CXL.mem, and/or CXL.cache protocol). In some embodiments, the NVM controller 208 includes a flash translation layer (FTL) 214 that receives the data access request and interfaces with the NVM 206 to read data from, and write data to, the NVM. In this regard, the FTL 214 may translate a physical address included in the data access request, to a flash block address. In doing so, the FTL 214 may engage in wear leveling to move data around the storage cells of the NVM 206 to evenly distribute the writes to the NVM 206.

In some embodiments, the prefetch engine 212 is configured to monitor memory requests from the host 100, and anticipate next requests. The data associated with the anticipated next requests may be prefetched into the device cache memory 204 for increasing the hit rate or, conversely, for minimizing the miss rate. In some embodiments, the prefetch engine 212 is configured to group the physical memory addresses of the memory requests into one or more regions (referred to as clusters) and sub-regions (referred to as active regions), using a two-level adaptive clustering model. The prefetch engine 212 may monitor the active regions for an amount of activity. The active regions may be promoted, demoted, or deleted, based on access profiles determined for the regions.

In some embodiments, data is prefetched into the device cache memory 204 based on the access profiles of the active regions. In some embodiments, the prefetch engine 212 communicates with the cache controller 210 for retrieving the data that is stored in the memory address that is to be prefetched. In some embodiments, the cache controller 210 or the FTL 214 is configured to translate a requested memory block address into a flash block address. The NMV controller 208 may retrieve the data from the flash block address, and forward the data to the cache controller 210. The cache controller 210 may select a cache address (e.g., a cache line 216) of the device cache memory 204, and store the data into the cache address.

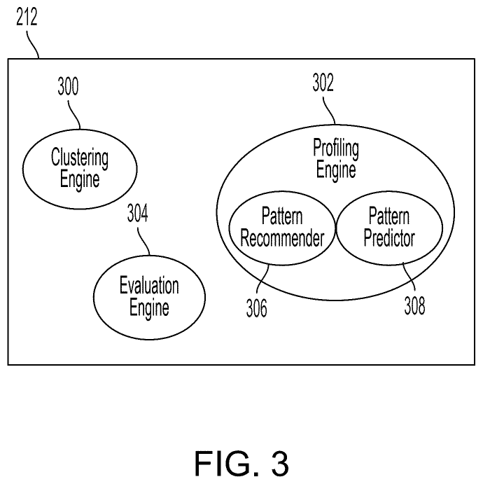

FIG. 3 depicts a block diagram of the prefetch engine 212 according to one or more embodiments. The prefetch engine 212 may include a clustering engine 300, profiling engine 302, and evaluation engine 304. Although the clustering engine 300, profiling engine 302, and evaluation engine 304 are assumed to be separate components, a person of skill in the art will recognize that one or more of the components may be combined or integrated into a single component, or further subdivided into further sub-components without departing from the spirit and scope of the inventive concept.

In some embodiments, the clustering engine 300 is configured to identify an address of a data access request (e.g., a load request) from an application running on the host 100, and identify an existing cluster or generate a new cluster for the address according to a first level of the clustering model. The size of the cluster may be preset (e.g., 8 GB). The address may be associated or grouped into an existing cluster if the address is within a range of addresses associated with the cluster. The range of addresses may be the addresses of the NVM 206. A new cluster may be generated centered around the address if the address cannot be grouped into an existing cluster.

For a second level of the clustering model, the clustering engine 300 may identify an existing active region within an identified cluster, or create a new active region. The initial size of the active region may be preset (e.g., 8 MB). The address may be associated or grouped into an existing active region if the address is within a range of addresses associated with the active region. The range of addresses may be the addresses of the NVM 206. A new active region may be generated centered around the address if the address cannot be grouped into an existing active region. The new active region may be associated with a default activity level (e.g., the lowest activity level). The activity level may change based on tracked activity of the active region. The size of the active region may also change based on changes to the activity level.

In some embodiments, one of the clustering engine 300, profiling engine 302, and/or evaluation engine 304 is configured to monitor or track activity of the clusters and/or active regions. One or more counters or parameter values (collectively referenced as counters) may be updated based on the monitored activity. For example, requests for memory addresses associated with the clusters and/or active regions may be monitored for updating counters relating to a number of accesses per cluster, a number of accesses per active region, last access time per active region, a number of misses per active region, a number of hits per active region, and/or the like.

In some embodiments, the profiling engine 302 is configured to generate access profiles for the active regions based on the tracked activities. The access profile may indicate, for example, whether the accesses are continuous or sequential, whether the accesses have a pattern, whether the accesses are random jumps to a hot region, and/or the like.

In some embodiments, the profiling engine 302 is configured to determine jump patterns of physical addresses associated with an active region of the memory device. In this regard, the profiling engine 302 includes a pattern recommender 306 and a pattern predictor 308. The pattern recommender 306 may be configured to determine whether a mathematical difference between the current address and a last address indicates a jump associated with an active region. For example, a jump may be detected if the mathematical difference is larger than a threshold value (e.g., a page size). The distance of the jump may be recorded in an array associated with the active region, and a counter may be incremented when the same distance is encountered for other consecutive memory accesses associated with the active region. In some embodiments, if the jump distance is encountered a threshold number of times, the pattern recommender 306 may select the jump distance as a starting jump distance for identifying a pattern of jumps for the active region. The starting jump distance may be added as a starting value of a pattern array.

In some embodiments, the pattern recommender 306 is configured to monitor jumps of addresses that occur after the starting jump distance for determining whether a pattern of jumps exists for the active region. In this regard, the pattern recommender 306 may monitor for a repeated jump distance after the starting jump distance. If an additional repeated jump distance is detected, the additional jump distance is added to the pattern array. The process may repeat for adding additional jump distances to the pattern array until a pattern is detected or a cancel condition is encountered. If a pattern is detected, the pattern recommender 306 may use the detected pattern for identifying one or more next memory addresses (e.g., next pages) that are to be accessed for the active region. A prefetch command may be transmitted for the predicted next memory addresses.

Whether the predicted next memory addresses are prefetched for the active region may depend, for example, on the activity level of the active region, in addition to other cache management considerations. In some embodiments, a certain allowance or credit to generate prefetch requests is provided to the active region based on the activity level of the active region. For example, an active region with the lowest activity level (e.g., activity level 1) may be allowed a lower amount of credit that an active region with the highest activity level (e.g., activity level 3).

In some embodiments, the evaluation engine 304 is configured to evaluate the active regions on a periodic (regular or irregular) basis. In some embodiments, the time of a last access to an active region may be examined during an evaluation period. The active region may be deleted upon detecting a criterion. The criterion may be lack of access to the active region for a period of time. For example, the active region may be deleted if there has been no access to the region for three evaluation periods, although embodiments are not limited thereto.

In some embodiments, the evaluation engine 304 is configured to promote or demote an active region from one activity level to another based on a score assigned to the active region. The score may be computed based on calculations performed using the counter values. The calculations may include, for example, a calculation (p1) of cluster populations, a calculation (p2) of the population of an active region, a miss ratio (p3) in the active region, and a calculation (p4) of a last access time ratio, as follows:

$$p 1 = cluster counter / global counter$$

$$p 2 = active region counter / cluster counter$$

$$p 3 = number of misses / ( number of misses + number of hits )$$

$$p 4 = active region last access time / global counter$$

where the global counter includes a count of requests to addresses associated with a cluster, and the active region counter includes a count of requests to addresses associated with the active region.

In some embodiments, a score for an active region is computed as a weighted aggregate of p1, p2, p3, and p4 as follows:

$$score = w 1 p 1 + w 2 p 2 + w 3 p 3 + w 4 p 4$$

A higher score may indicate higher activity in the active region. A threshold minimum score associated with an activity level may need to be achieved in order for the active region to be promoted or demoted to respectively a higher or lower activity level. In some embodiments, the total number of activity levels is three, although embodiments are not limited thereto. In some embodiments, the activity level assigned to an active region determines the allowance or credit of prefetch requests that may be processed for the active region.

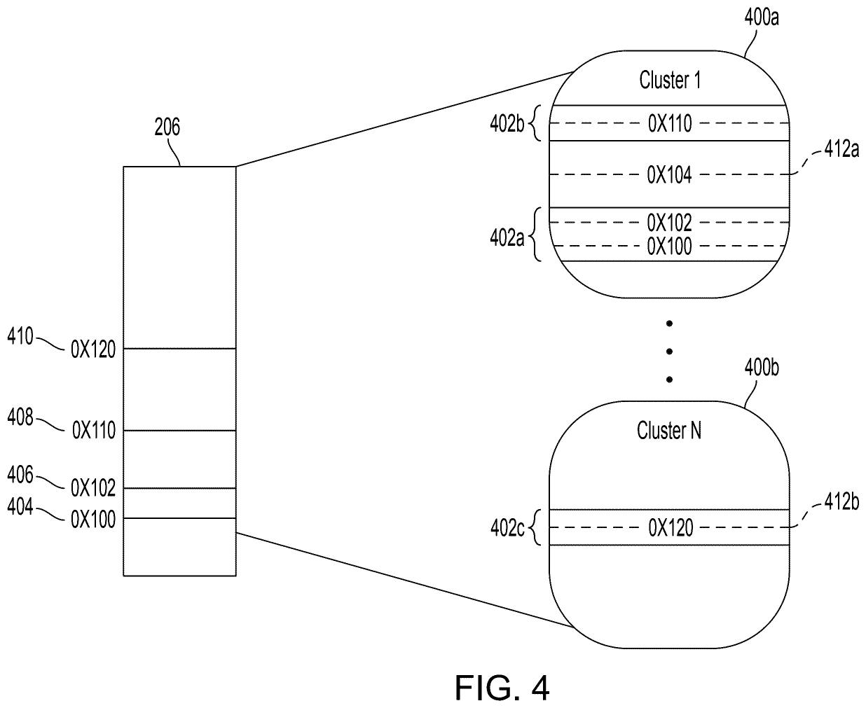

FIG. 4 depicts a conceptual block diagram of clusters 400a, 400b (collectively referenced as 400) and active regions (ARs) 402a-402c (collectively referenced as 402) according to one or more embodiments. The clusters 400 and active regions 402 may be generated based on addresses identified in the data access requests (e.g., load requests) from one or more applications running on the host 100. The clusters 400 may be of a fixed size (e.g., 8 GB), centered around a cluster center address (cluster center) 412a, 412b (collectively referenced as 412) of the respective cluster 400. The cluster center 412 may be updated as addresses are added to the cluster. In this manner, the addresses of the upper and lower boundaries of the cluster may adjust as new addresses are added, although the size of the cluster may remain fixed.

In some embodiments, the active regions 402 are initialized to a default size and centered around an active region (AR) center address (AR center) (not shown). The AR center may be updated as addresses are added to the active region 402. The size of the active regions may also be adjusted based on activities of the active regions. For example, an active region 402 with an increased activity level may be split into two or more active regions of reduced sizes.

In the example of FIG. 4, the first cluster 400a and the first active region 402a may be generated based on receipt of the first address 404. The second address 406 may belong to a range of addresses associated with the first active region 402a. Thus, the second address 406 may be associated with the first active region 402a upon receipt of a data access request including the second address 406.

The third address 408 may be inside the range of addresses associated with the first cluster 400a, but outside of the range of addresses associated with the first active region 402a. Thus, the second active region 402b may be created around the third address 408 upon receipt of a data access request for the third address.

The fourth address 410 may be outside of the range of addresses associated with the first cluster 400a. Thus, the second cluster 400b and the third active region 402c may be created around the fourth address 410 upon receipt of a data access request for the fourth address.

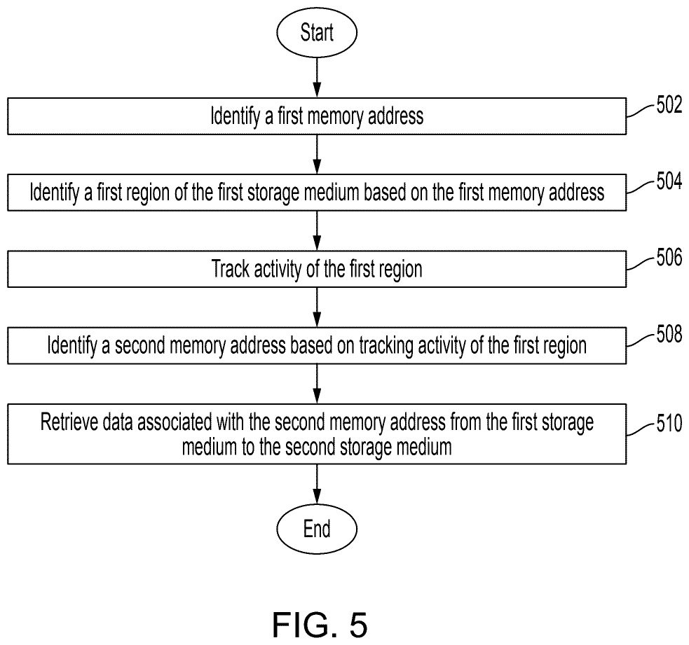

FIG. 5 depicts a flow diagram of a process for adaptive clustering for data prefetching according to one or more embodiments. The process starts, and in act 502, the clustering engine 300 identifies an address (e.g., a first memory address) of a data access request by an application running on the host 100.

For purposes of the example of FIG. 5, it is assumed that a cluster has been identified for the address. In act 504, the clustering engine 300 identifies an active region (e.g., a first region of a first storage medium) of the cluster based on the address. The active region may be an existing active region that encompasses the address, or a new active region generated based on the address. Whether an existing active region encompasses the address may be based on computing a difference between the address and an address (e.g., a third memory address) of the center of the active region.

In act 506, one of the clustering engine 300, profiling engine 302, and/or evaluation engine 304 tracks activity of the active region. In some embodiments, the profiling engine 302 generates an access profile based on the tracking of the activity.

In the event that the access profile indicates that prefetching is appropriate for an active region, the profiling engine 302 identifies, in act 508, a second memory address based on tracking activity of the first region.

In act 510, the prefetch engine 212 retrieves (e.g., prefetches) data associated with the second memory address from the first storage medium (e.g., the NVM 206) to a second storage medium (e.g., cache memory 204).

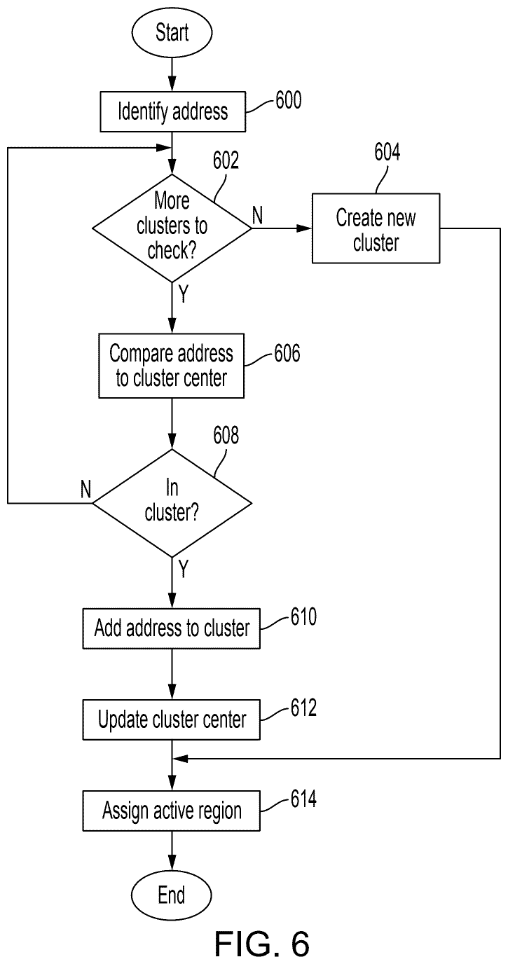

FIG. 6 depicts a flow diagram of a process for assigning an address to a cluster 400 according to one or more embodiments. The process starts, and in act 600, the clustering engine 300 identifies an address of a data access request.

In act 602, the clustering engine 300 determines whether there are existing clusters 400 that need to be checked for determining whether the address should be added to an existing cluster. If the answer is NO, a new cluster 400 is generated in act 604. The cluster 400 may be of a preset size centered around the address.

If, however, there are clusters that need to be checked, the address is compared, in act 606, against a cluster center (e.g., center address 412), and a determination is made in act 608, as to whether the address is within the boundaries of the cluster 400. For example, a mathematical difference between the address and the cluster center address may be computed, and a determination may be made as to whether the difference is within a maximum distance from the cluster center. For example, if the cluster size is 8 GB, the maximum distance may be 4 GB from the cluster center.

If the address is within the cluster 400, the clustering engine 300 adds the address to the cluster 400 in act 610.

In act 612, the clustering engine 300 updates the center address of the cluster 400. The new center address may be an average of the added address and previously accessed addresses that have already been associated to the cluster.

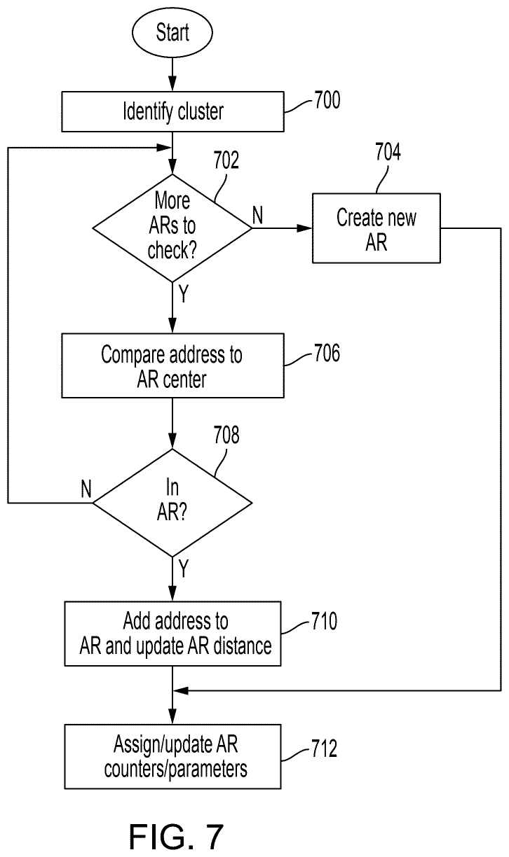

In act 614, the clustering engine 300 assigns the address to an active region as discussed in further detail with respect to FIG. 7.

FIG. 7 depicts a block diagram of a process of act 614 for assigning an address to an active region 402 according to one or more embodiments. The process starts, and in act 700, the cluster assigned to the address is identified.

In act 702, a determination is made as to whether there are existing active regions 402 to which the address could be added. If the answer is NO, a new active region 402 is created in act 704.

If there are exiting active region to which the address could be added, the address is compared, in act 706, against an AR center, and a determination is made in act 708 as to whether the address is within the boundaries of the active region (referred to as an AR distance) 402. For example, a mathematical difference between the address and the AR center address may be computed, and a determination may be made as to whether the difference is within a maximum distance from the AR center.

If the address is within the active region 402, the clustering engine 300 adds the address to the active region in act 710, and updates the AR distance to be the difference between the address and the AR center address.

In act 712, one or more counters and/or parameter values associated with the active region are updated. For example, an access counter for the cluster and active region may be increased, an access time may be updated, and/or a miss or hit counter may be updated based on whether the access to the address resulted in a cache miss or hit.

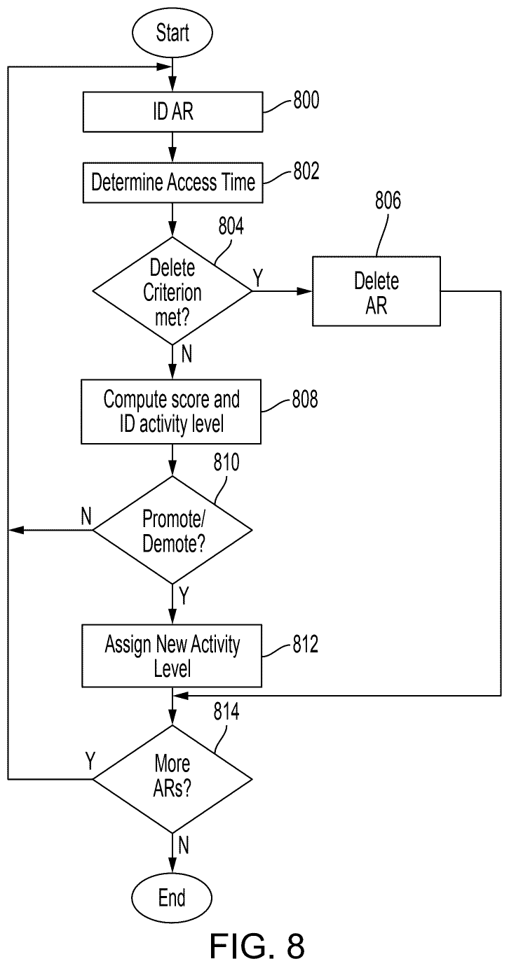

FIG. 8 depicts a flow diagram of a process for evaluating active regions 402 according to one or more embodiments. The evaluation may be performed in response to the evaluation engine 304 detecting a trigger. The trigger may be, for example, detecting the threshold number (e.g., 5000) of memory accesses, detecting a certain passage of time since a last evaluation, detecting a status of the memory device, and/or the like.

In act 800, the evaluation engine 304 identifies an active region 402 that is to be evaluated.

In act 802, the evaluation engine 304 determines a time of an access (e.g., a last access) of an address associated with the active region 402.

In act 804, a determination is made as to whether a criterion for deleting the active region 402 has been satisfied. The criterion may be, for example, that no memory addresses of the active region have been accessed for a certain number (e.g., three) evaluation rounds.

If the criterion has been detected, the active region 402 is deleted in act 806. In some embodiments, if no other active regions exist in the corresponding cluster, the cluster is also deleted.

If the criterion for deletion has not been detected, a score is computed in act 808. The score may be computed based on calculations performed using the counter values. For example, the score may be a weighted aggregate of the population of the corresponding cluster, the population of the active region 402, the miss ratio in the active region, and a last access time ratio.

In act 810, a determination is made as to whether the active region 402 should be promoted or demoted from a current activity level based on the computed score. An activity level may be associated with a threshold score that is to be satisfied prior to an active region being assigned the activity level. An active region 402 having a first activity level may be promoted to a higher activity level if the score of the active region is at or above the threshold score associated with the higher activity level. An active region 402 having a first activity level may be demoted to a lower activity level if the score of the active region is at or below the threshold score associated with the lower activity level.

In act 812 the evaluation engine 304 assigns to the active region the activity level that corresponds to the computed score. In some embodiments, an active region 402 with a sufficiently high activity level (e.g., activity level 3) may be split into one or more regions. For example, an active region of a size of 32 MB that is assigned to the high activity level may be split into two active regions of size 16 MB each, where each split active region may be associated with the high activity level. The splitting of the active region may provide additional (e.g., double) credit for accessing the device cache memory 204.

In act 814, a determination is made as to whether there are more active regions 402 to evaluate. If the answer is YES, the evaluation process returns to act 800 for evaluating the other active regions.

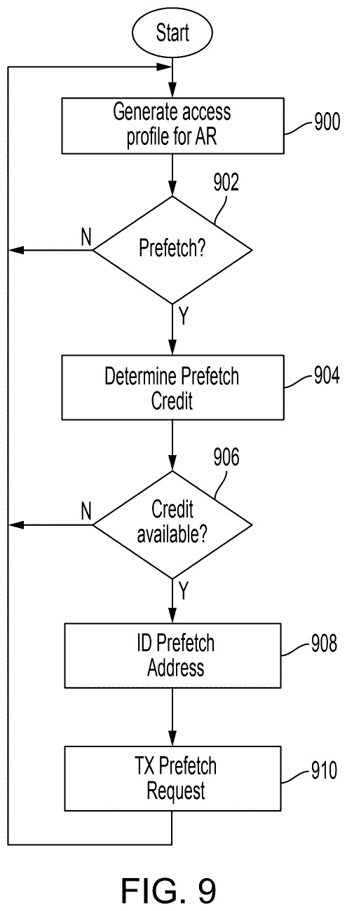

FIG. 9 depicts a flow diagram of a prefetching process according to one or more embodiments. The process starts, and in act 900, the profiling engine 302 generates an access profile for an active region.

In act 902, the prefetch engine 212 determines whether the access profile for the active region 402 calls for a prefetching action. For example, prefetching may be warranted if the access profile indicates that the accesses are continuous or sequential, that the accesses have a pattern, that the accesses are random jumps to a hot sub-region of the active region, and/or the like.

If prefetching is warranted, the prefetch engine 212 determines, in act 904, an amount of prefetching allowance or credit for the active region 402. The amount of credit may be based on the activity level assigned to the active region 402. In some embodiments, the higher the activity level, the higher the amount of credit, up to a maximum activity level and credit.

In act 906, a determination is made as to whether prefetching credits are available for the active region 402. If the answer is NO, the prefetch engine 212 refrains from transmitting a prefetch request to the cache controller 210. If the answer is YES, the prefetch engine 212 identifies, in act 908, one or more prefetch addresses based on the access profile.

In act 910, the prefetch engine 212 transmits a prefetch command to the cache controller 210. In some embodiments, the cache controller 210 processes the prefetch command based on available capacity of the device cache memory 204. If space is available in the device cache memory the requested prefetch addresses may be prefetched from the NVM 206 to the memory 204. If space is not available in the device cache memory, data may be evicted from the memory prior to fulfilling the prefetch command.

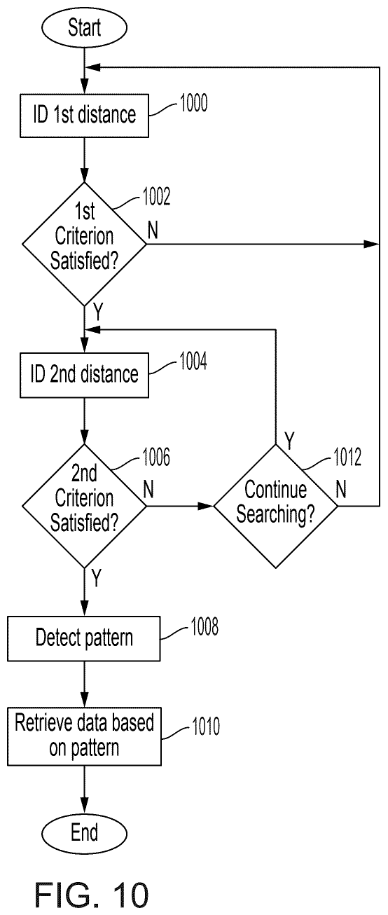

FIG. 10 depicts a flow diagram of a process for detecting jump patterns of addresses assigned to an active region according to one or more embodiments. The process starts, and in act 1000, the profiling engine 302 (e.g., the pattern recommender 306) identifies a first distance between first memory addresses (e.g., consecutive memory addresses) accessed by a computing device. In some embodiments, the first memory addresses are assigned to the same active region. In this manner, the determination of whether a jump pattern exists is performed on a per active region basis.

In act 1002, a determination is made as to whether the first distance satisfies a first criterion. In some embodiments, the first criterion is satisfied upon detecting a first preset number of accesses (e.g., four accesses) associated with the first distance.

If the first distance satisfies the first criterion, the profiling engine 302 (e.g., the pattern predictor 308) identifies, in act 1004, a second distance between second memory addresses (e.g., consecutive memory addresses) accessed by a computing device.

In act 1006, the profiling engine 302 determines whether the second distance satisfies a second criterion. In some embodiments, the second criterion is satisfied upon detecting a second preset number of accesses (e.g., four accesses) associated with the second distance.

If the answer is YES, and the second criterion is satisfied, a jump pattern is detected in act 1008. The jump pattern may include, for example, the first distance and the second distance.

In act 1010, the profiling engine 302 retrieves (e.g., prefetches) data from the NVM 206 based on the jump pattern. For example, if the jump pattern includes a first distance (e.g., 10) and a second distance (e.g., 20), the profiling engine 302 monitors for a memory access that is a first distance (e.g., 10) away from a prior memory access. Based on identifying the first distance, the profiling engine prefetches an address that has the second distance (e.g., 20) from the memory access. The prefetched address may be stored in the storage memory 204.

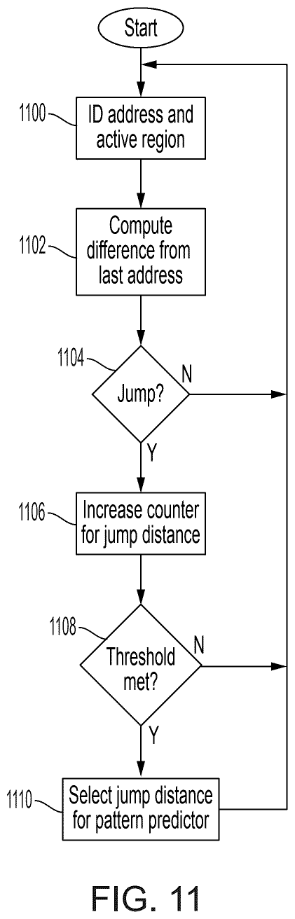

FIG. 11 depicts a block diagram of a process executed by the pattern recommender 306 of the profiling engine 302 for identifying a starting jump distance from which a jump pattern may be formed according to one or more embodiments. The process starts, and in act 1100, the pattern recommender 306 identifies a current address of a data access request by an application running on the host 100. The pattern recommender 306 further identifies the active region 402 to which the current address is assigned.

In act 1102 the pattern recommender 306 computes a difference between the current address and a last accessed address in the active region.

In act 1104, a determination is made as to whether the difference of the accessed memory addresses indicates a jump. In some embodiments, the current memory access may be deemed to be a jump if the computed difference is larger than a threshold value (e.g., a page size).

If the answer is NO, and the difference of the accessed memory addresses do not indicate a jump, the process returns to check a next address.

If the answer is YES, and a jump is detected based on the difference of the accessed memory addresses, the pattern recommender 306 includes the jump distance in a jump array (if the jump distance is not already there), or identifies the jump distance from the jump array (if the jump distance is already in the array). In some embodiments, the pattern recommender 306 increases a jump counter associated with the jump distance in act 1106.

In act 1108 a determination is made as to whether a threshold value has been reached for identifying the jump distance as a start of a possible jump pattern. For example, the threshold value may be met if the value of the jump counter for the jump distance is equal to 4, although embodiments are not limited thereto.

If the threshold value has been reached, the jump distance is selected, in act 1110 for making a pattern prediction based on the jump distance. The selected jump distance may be added to a pattern array as a start distance of a possible jump pattern. If answer is NO, and the threshold value has not been reached, the process returns to check a next address.

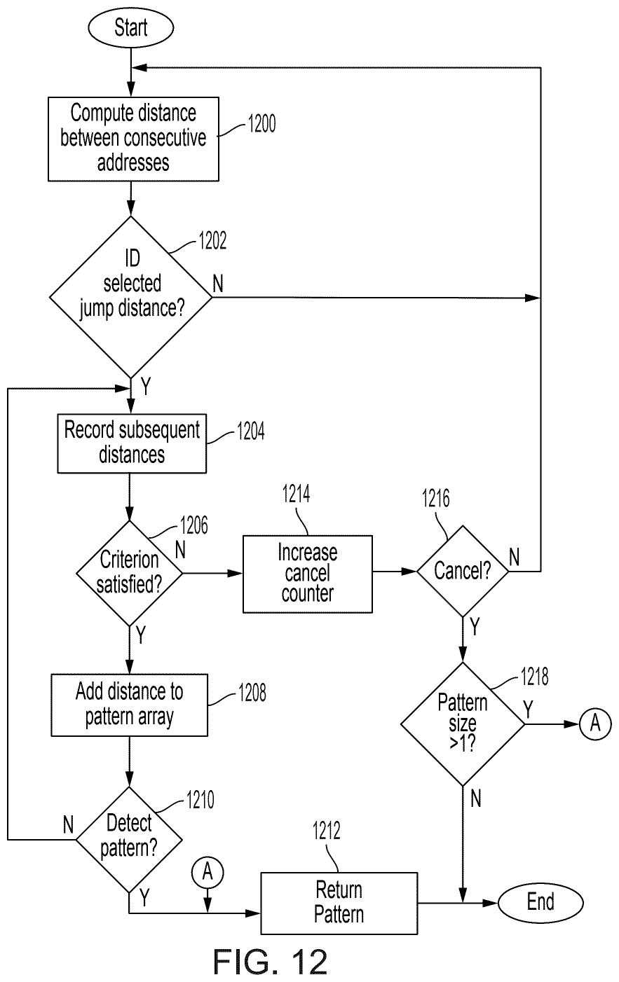

FIG. 12 depicts a flow diagram of a process for identifying a jump pattern according to one or more embodiments. The process starts, and in act 1200, the pattern predictor 308 included in the profiling engine 302 monitors the distance between consecutive memory accesses on a per active region basis. In this regard, the pattern predictor 308 may compute a distance between a currently accessed memory address and a previously accessed memory address.

In act 1202, a determination is made as to whether the distance is equal to a jump distance that has been selected by the pattern recommender 306 as start distance of a potential jump pattern.

If the answer is YES, the pattern predictor 308 records, in act 1204, the distances of next memory accesses following the current memory access. For example, if the jump distance selected by the pattern recommender 306 is 10, the pattern predictor 308 monitors the memory accesses to identify a current memory access that has a jump distance of 10 from a previous memory access associated with the active region. Once the jump distance is identified, the pattern predictor 308 computes and records a preset number (e.g., 8) of the next memory access distances that follow the current memory access.

In act 1206, a determination is made as to whether a criterion for detecting a pattern of jumps has been satisfied based on the next memory access distances. In some embodiments, the criterion is satisfied if the distance of one of the subsequent memory accesses is repeated a threshold number of times (e.g., four times).

If the criterion for detecting a pattern of jumps is satisfied for one of the next memory access distances, the distance is added to the pattern array in act 1208.

In act 1210, a determination is made as to whether a pattern may be identified based on the entries in the pattern array. In some embodiments, a pattern is detected if the number of entries in the pattern array are even and symmetric.

If the answer is YES, and the entries in the pattern array are even and symmetric, a pattern is returned in act 1212. In some embodiments, the access profile of the active region is associated with the jump pattern.

If the answer is NO, the process returns to act 1204 to compute and record additional subsequent distances.

Referring again to act 1206, if the criterion for detecting a pattern of jumps has not been satisfied (e.g., none of the subsequent memory accesses is repeated the threshold number of times), the pattern predictor 308 increases a cancel counter in act 1214.

In act 1216, a determination is made as to whether the search for a pattern that is based on the initial jump distance selected by the pattern recommender 306 should be canceled. For example, a determination to cancel may be made if the cancel counter reaches a threshold value (e.g., 2).

If the answer is NO, the process returns to act 1200 to continue to monitor the distance of memory accesses by the host 100 for determining a jump pattern.

If the answer is YES, and the search for the jump pattern is to be canceled, the pattern predictor 308 determines, in act 1218, whether the number of jump distances recorded in the pattern array is greater than 1. If the answer is YES, the jump distances recorded in the pattern are returned as the identified pattern. In some embodiments, the access profile of the active region is associated with the jump pattern.

If the answer is NO, no pattern is detected, and the process ends.

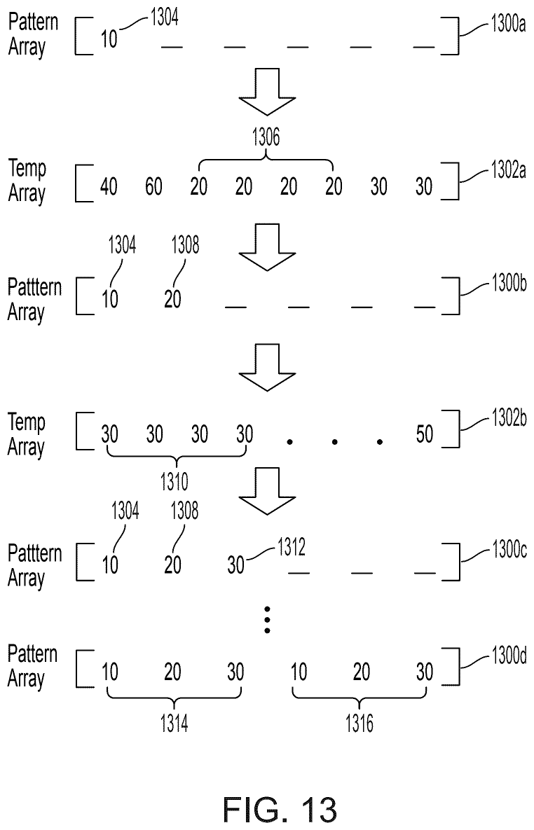

FIG. 13 depicts a conceptual diagram of the jump distances that are monitored and recorded by the pattern predictor 308 for determining a jump pattern for an active region according to one or more embodiments. As the pattern predictor 308 monitors the jump distances associated with the active region, potential jump distances that may form the jump pattern are tracked in a pattern array 1300a-1300d (collectively referenced as 1300). In some embodiments, the pattern array 1300 is configured to store a jump pattern that includes six jump distances, although embodiments are not limited thereto.

In some embodiments, an initial jump distance 1304 selected by the pattern recommender 306 is included in the pattern array 1300a as a potential start distance of the jump pattern. In the example of FIG. 13, the initial jump distance 1304 is 10.

In some embodiments, the pattern predictor 308 monitors memory accesses associated with the active region for detecting the initial jump distance 1304. When the initial jump distance 1304 is identified for a current memory access, the pattern predictor 308 monitors a preset number (e.g., 8) of next jump distances associated with the active region that follow the current memory access. The next jump distances may be stored in a temporary array 1302a.

In some embodiments, the pattern predictor 308 determines whether a threshold number (e.g., 4) of the next jump distances are repeated in consecutive memory accesses. In the example of FIG. 13, at least one of the next jump distances (jump distance 20) 1306 is repeated the threshold number of times. The repeated jump distance is stored in the pattern array 1300b as a next potential jump distance 1308 of a jump pattern. The temporary array may be cleared when the repeated jump distance 1308 is identified or when no distances are identified that are repeated the threshold number of times after the preset number of memory accesses have been monitored.

In some embodiments, as jump distances are added to the pattern array 1300, the pattern predictor 308 determines whether the jump distances added so far qualify as a jump pattern. In some embodiments, the entries in the pattern array qualify as a jump pattern if there are an even number of entries and the entries are symmetric. In the example of FIG. 13, the jump distances 1304, 1308 stored in the pattern array 1300b do not satisfy the criterion of being a jump pattern because, although the number is entries is even, the entries are not symmetric.

In continuing the pattern recognition process, the pattern predictor 308 monitors memory accesses associated with the active region for detecting memory accesses that result in the initial jump distance 1304 followed by the next repeated jump distance 1308. When the initial jump distance 1304 followed by the next repeated jump distance 1308 is identified, the pattern predictor 308 monitors the next jump distances associated with the active region, and stores the next jump distances in the temp array 1302b. In the example of FIG. 13, a repeated jump distance (e.g., jump distance of 30) 1310 is identified and stored in the temporary array 1302b. The repeated jump distance 1310 may be added to the pattern array 1300c as a next repeated jump distance 1312. In the example of FIG. 13, no jump pattern is identified based on the entries in the pattern array 1300c, as the entries in the array are neither even nor symmetric.

The process of adding jump distances to the pattern array may continue until the pattern array 1300d is generated. The pattern predictor 308 may evaluate the pattern array 1300d and determine that the criterion for detecting a pattern is met for the entries in pattern array 1300d. For example, the pattern predictor 308 may detect that the number of entries of the pattern array 1300 is even, and the jump distances are symmetric. For example, the first half of the entries 1314 are symmetric to the second half of the entries 1316 of the pattern array 1300d. In some embodiments, the pattern predictor 308 returns the jump distances in the first half of the entries 1314 (or the second half of the entries 1316) as the final detected jump pattern. The access profile of the active region may be set based on the final detected jump pattern.

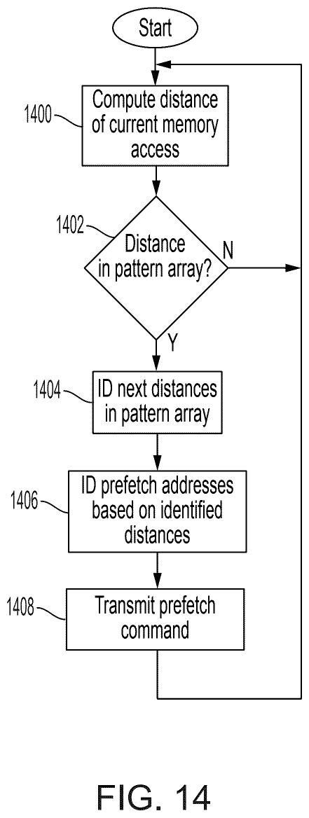

FIG. 14 depicts a flow diagram of a process for identifying prefetch addresses based on a detected jump pattern according to one or more embodiments. It is assumed, for purposes of FIG. 14, that the active region for which prefetching is to be conducted has a sufficient amount of prefetching allowance or credit for transmitting a prefetch request. Accordingly, the process starts, and in act 1400, the prefetch engine 212 computes a distance of a current memory access relative to a prior memory access.

In act 1402, the prefetch engine 212 determines whether the distance is included as the initial jump distance 1304 in the pattern array 1300. If the answer is NO, the prefetch engine 212 continues to monitor the memory accesses for the initial jump distance.

If the answer is YES, the prefetch engine 212 identifies, in act 1404, the next jump distances 1308, 1312 identified in the pattern array 1300.

In act 1406, the prefetch engine 212 identifies prefetch addresses based on the identified next jump distances 1308, 1312. For example, if the next jump distances 1308, 1312 following the initial jump distance 1304 are 20 and 30, the prefetch engine 212 identifies a first prefetch memory address with a distance of 20 from the last accessed memory address, and a second prefetch memory address with a distance of 30 from the identified first prefetch memory address.

In act 1408, the prefetch engine 212 transmits one or more prefetch commands for the identified prefetch memory addresses to the cache controller 210.

One or more embodiments of the present disclosure may be implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for pattern recognition have been specifically described and illustrated herein, many modifications and variations will be apparent to those skilled in the art. Accordingly, it is to be understood that systems and methods for pattern recognition according to principles of this disclosure may be embodied other than as specifically described herein. The disclosure is also defined in the following claims, and equivalents thereof.

The systems and methods for pattern recognition may contain one or more combination of features set forth in the below statements.

Statement 1. A storage device comprising: a first storage medium; a processor configured to: identify a first distance between first memory addresses accessed by a computing device that satisfies a first criterion; based on identifying the first distance that satisfies the first criterion, identify a second distance between second memory addresses accessed by the computing device that satisfies a second criterion; based on identifying the second distance that satisfies the second criterion, detect a pattern including the first distance and the second distance; and retrieve from the first storage medium, based on the pattern, data associated with a third memory address.

Statement 2. The storage device of Statement 1 further comprising a second storage medium including volatile memory, wherein the processor is configured to retrieve data from the first storage medium and store the data in the second storage medium.

Statement 3. The storage device of Statement 1, wherein the first criterion is satisfied upon detecting a first preset number of accesses associated with the first distance.

Statement 4. The storage device of Statement 3, wherein the second criterion is satisfied upon detecting a second preset number of accesses associated with the second distance.

Statement 5. The storage device of Statement 1, wherein the processor is further configured to: based on identifying the second distance that satisfies the second criterion, identify a third distance between fourth memory addresses, and a fourth distance between fifth memory addresses different from the third distance; and generate a signal based on identifying the third distance and the fourth distance.

Statement 6. The storage device of Statement 1, wherein the processor is further configured to: based on identifying the second distance that satisfies the second criterion, identify the first distance between fourth memory addresses, and the second distance between fifth memory addresses; and generate a signal based on identifying the first distance between the fourth memory addresses, and the second distance between the fifth memory addresses.

Statement 7. The storage device of Statement 1, wherein the processor is further configured to: identify a first region of the first storage medium based on the first memory addresses; determine that the second memory addresses are associated with the first region; and based on determining that the second memory addresses are associated with the first region, identify the second distance between the second memory addresses.

Statement 8. The storage device of Statement 7, wherein the first region is associated with a first range of addresses, and the processor is further configured to: identify a third memory address from the first range of addresses; compute a difference between at least one of the first memory addresses and the third memory address; and determine based on the difference that the at least one of the first memory addresses is within a threshold distance from the third memory address.

Statement 9. The storage device of Statement 7, wherein the processor is further configured to: identify a second region based on the first memory addresses, wherein the second region is associated with a second range of addresses, wherein the second region is of a preset size, wherein the second region includes the first region.

Statement 10. The storage device of Statement 7, wherein the processor is configured to: identify a second region based on at least one of the first memory addresses; and identify the first region based on the processor being configured to identify the second region.

Statement 11. A method comprising: identifying a first distance between first memory addresses accessed by a computing device that satisfies a first criterion;

based on identifying the first distance that satisfies the first criterion, identifying a second distance between second memory addresses accessed by the computing device that satisfies a second criterion; based on identifying the second distance that satisfies the second criterion, detecting a pattern including the first distance and the second distance; and retrieving from a first storage medium, based on the pattern, data associated with a third memory address.

Statement 12. The method of Statement 11 further comprising retrieving data from the first storage medium and storing the data in a second storage medium including volatile memory.

Statement 13. The method of Statement 11, wherein the first criterion is satisfied upon detecting a first preset number of accesses associated with the first distance.

Statement 14. The method of Statement 13, wherein the second criterion is satisfied upon detecting a second preset number of accesses associated with the second distance.

Statement 15. The method of Statement 11 further comprising:
based on identifying the second distance that satisfies the second criterion, identifying a third distance between fourth memory addresses, and a fourth distance between fifth memory addresses different from the third distance; and
generating a signal based on the identifying of the third distance and the fourth distance.

Statement 16. The method of Statement 11 further comprising:

based on the identifying of the second distance that satisfies the second criterion, identifying the first distance between fourth memory addresses, and the second distance between fifth memory addresses; and generating a signal based on the identifying of the first distance between the fourth memory addresses, and the second distance between the fifth memory addresses.

Statement 17. The method of Statement 11 further comprising: identifying a first region of the first storage medium based on the first memory addresses; determining that the second memory addresses are associated with the first region; and based on determining that the second memory addresses are associated with the first region, identifying the second distance between the second memory addresses.

Statement 18. The method of Statement 17, wherein the first region is associated with a first range of addresses, the method further comprising: identifying a third memory address from the first range of addresses; computing a difference between at least one of the first memory addresses and the third memory address; and determining based on the difference that the at least one of the first memory addresses is within a threshold distance from the third memory address.

Statement 19. The method of Statement 17 further comprising: identifying a second region based on the first memory addresses, wherein the second region is associated with a second range of addresses, wherein the second region is of a preset size, wherein the second region includes the first region.

Statement 20. The method of Statement 17 further comprising: identifying a second region based on at least one of the first memory addresses; and identifying the first region based on the identifying of the second region.

What is claimed is:

1. A storage device comprising:
a first storage medium;
a processor configured to:
identify a first distance between first memory addresses accessed by a computing device that satisfies a first criterion;
based on identifying the first distance that satisfies the first criterion, identify a second distance between second memory addresses accessed by the computing device that satisfies a second criterion;
based on identifying the second distance that satisfies the second criterion, detect a pattern including the first distance and the second distance; and
retrieve from the first storage medium, based on the pattern, data associated with a third memory address.

2. The storage device of claim 1 further comprising a second storage medium including volatile memory, wherein the processor is configured to retrieve data from the first storage medium and store the data in the second storage medium.

3. The storage device of claim 1, wherein the first criterion is satisfied upon detecting a first preset number of accesses associated with the first distance.

4. The storage device of claim 3, wherein the second criterion is satisfied upon detecting a second preset number of accesses associated with the second distance.

5. The storage device of claim 1, wherein the processor is further configured to:
based on identifying the second distance that satisfies the second criterion, identify a third distance between fourth memory addresses, and a fourth distance between fifth memory addresses different from the third distance; and
generate a signal based on identifying the third distance and the fourth distance.

6. The storage device of claim 1, wherein the processor is further configured to:
based on identifying the second distance that satisfies the second criterion, identify the first distance between fourth memory addresses, and the second distance between fifth memory addresses; and
generate a signal based on identifying the first distance between the fourth memory addresses, and the second distance between the fifth memory addresses.

7. The storage device of claim 1, wherein the processor is further configured to:
identify a first region of the first storage medium based on the first memory addresses;
determine that the second memory addresses are associated with the first region; and
based on determining that the second memory addresses are associated with the first region, identify the second distance between the second memory addresses.

8. The storage device of claim 7, wherein the first region is associated with a first range of addresses, and the processor is further configured to:
identify a third memory address from the first range of addresses;
compute a difference between at least one of the first memory addresses and the third memory address; and
determine based on the difference that the at least one of the first memory addresses is within a threshold distance from the third memory address.

9. The storage device of claim 7, wherein the processor is further configured to:
identify a second region based on the first memory addresses, wherein the second region is associated with a second range of addresses, wherein the second region is of a preset size, wherein the second region includes the first region.

10. The storage device of claim 7, wherein the processor is configured to:
identify a second region based on at least one of the first memory addresses; and
identify the first region based on the processor being configured to identify the second region.

11. A method comprising:
identifying a first distance between first memory addresses accessed by a computing device that satisfies a first criterion;
based on identifying the first distance that satisfies the first criterion, identifying a second distance between second memory addresses accessed by the computing device that satisfies a second criterion;
based on identifying the second distance that satisfies the second criterion, detecting a pattern including the first distance and the second distance; and
retrieving from a first storage medium, based on the pattern, data associated with a third memory address.

12. The method of claim 11 further comprising retrieving data from the first storage medium and storing the data in a second storage medium including volatile memory.

13. The method of claim 11, wherein the first criterion is satisfied upon detecting a first preset number of accesses associated with the first distance.

14. The method of claim 13, wherein the second criterion is satisfied upon detecting a second preset number of accesses associated with the second distance.

15. The method of claim 11 further comprising:
based on identifying the second distance that satisfies the second criterion, identifying a third distance between fourth memory addresses, and a fourth distance between fifth memory addresses different from the third distance; and
generating a signal based on the identifying of the third distance and the fourth distance.

16. The method of claim 11 further comprising:
based on the identifying of the second distance that satisfies the second criterion, identifying the first distance between fourth memory addresses, and the second distance between fifth memory addresses; and
generating a signal based on the identifying of the first distance between the fourth memory addresses, and the second distance between the fifth memory addresses.

17. The method of claim 11 further comprising:
identifying a first region of the first storage medium based on the first memory addresses;
determining that the second memory addresses are associated with the first region; and
based on determining that the second memory addresses are associated with the first region, identifying the second distance between the second memory addresses.

18. The method of claim 17, wherein the first region is associated with a first range of addresses, the method further comprising:
identifying a third memory address from the first range of addresses;
computing a difference between at least one of the first memory addresses and the third memory address; and
determining based on the difference that the at least one of the first memory addresses is within a threshold distance from the third memory address.

19. The method of claim 17 further comprising:
identifying a second region based on the first memory addresses, wherein the second region is associated with a second range of addresses, wherein the second region is of a preset size, wherein the second region includes the first region.

20. The method of claim 17 further comprising:
identifying a second region based on at least one of the first memory addresses; and
identifying the first region based on the identifying of the second region.
